(19) United States
(12) Patent Application Publication
(10) Pub. No.: US 2022/0265021 A1
(43) Pub. Date: Aug. 25, 2022

(54) BLADE SHAVER CRADLE

(71) Applicant: WISELY CO.,LTD., Seoul (KR)

(72) Inventor: Dong Wook Kim, Seoul (KR)

(21) Appl. No.: 17/642,498

(22) PCT Filed: Oct. 15, 2020
(86) PCT No.: PCT/KR2020/014071

§ 371 Date: Mar. 11, 2022

(30) Foreign Application Priority Data
Oct. 18, 2019 (KR) 20-2019-0004219

(51) Int. Cl. A45D 27/29; B26B 21/40

(52) U.S. Cl. CPC A45D 27/29; B26B 21/4037

(57) ABSTRACT

The present disclosure relates to a blade shaver cradle capable of cradling a blade shaver by receiving a predetermined area of the blade shaver, the blade shaver including a blade part and a handle, the blade shaver cradle including: a front part including a first bottom plate and a front plate, the front plate extending upwards in an area other than a rear surface of the first bottom plate to form a first receiving space that is open; and a rear part including a second bottom plate and a rear plate, the rear plate extending upwards in an area other than a front surface of the second bottom plate to form a second receiving space that is open.

### TECHNICAL FIELD

The present disclosure relates to a blade shaver cradle, and more particularly, to a blade shaver cradle capable of maintaining the cutting performance and durability by preventing corrosion of a blade part of a blade shaver by effectively removing moisture from the blade part, and simultaneously cradling the blade shaver more conveniently.

### BACKGROUND ART

Blade shavers that are widely used by general adult men are more convenient to use than electric shavers that require continual charging for use and are relatively difficult to maintain and manage. For this reason, recently, blade shavers are manufactured by applying a material having excellent cutting performance and excellent corrosion resistance. However, even though blades have excellent corrosion resistance, because blade shavers are always exposed to moisture, the cutting performance is reduced due to corrosion by the external environment, and thus, during shaving, damage to the skin may occur, and a usage cycle is reduced.

In order to prevent this problem, after a blade shaver is used, moisture on the blade shaver should be completely removed. However, in busy daily life, it is very cumbersome to completely remove moisture on a shaver after shaving. Thus, usually, after a shaver is used, the shaver is usually laid down or placed in a case, and thus moisture remains on a blade part or it takes a long time for moisture to be removed.

Accordingly, there is a need for a method of maintaining the cutting performance and increasing durability of a shaver blade by preventing the shaver blade from being exposed to moisture by effectively removing moisture on a blade shaver.

### DISCLOSURE OF THE INVENTION

### Technical Problem

The present disclosure is directed to providing a blade shaver cradle capable of maintaining the cutting performance and durability by preventing corrosion of a blade part of a blade shaver by effectively removing moisture from the blade part, and simultaneously cradling the blade shaver more conveniently.

An object of the present disclosure is not limited thereto, and other objects not mentioned will be clearly understood by those of ordinary skill in the art to which the present disclosure belongs from the following description.

### Technical Solution

In order to achieve the object, a blade shaver cradle capable of cradling a blade shaver by receiving a predetermined area of the blade shaver, the blade shaver including a blade part and a handle, includes: a front part comprising a first bottom plate and a front plate, the front plate extending upwards in an area other than a rear surface of the first bottom plate to form a first receiving space that is open; and a rear part comprising a second bottom plate and a rear plate, the rear plate extending upwards in an area other than a front surface of the second bottom plate to form a second receiving space that is open, wherein, the front part and the rear part are coupled such that the rear surface of the first bottom plate and the front surface of the second bottom plate are pivotable, and an open rear surface of the front plate and an open front surface of the rear plate are coupled to each other to form a receiving space in which the blade part and an area of the handle may be received.

Here, at least one of the first bottom plate and the second bottom plate may include support portions spaced apart from each other in a direction perpendicular to the blade part and extending upwards from both sides of an area not being in contact with a blade of the blade part.

Here, the first bottom plate and the second bottom plate may include at least one close contact prevention portion protruding and extending downward from bottom surfaces of the first bottom plate and the second bottom plate so that the first bottom plate and the second bottom plate are not in close contact with and spaced apart from a cradle bottom surface.

### Advantageous Effects

In a blade shaver cradle according to the present disclosure, a front part and a rear part are pivotably coupled to each other, and an open rear surface of a front plate and an open front surface of a rear plate are coupled to each other to form a receiving space in which the blade part and an area of the handle can be received. Accordingly, moisture on the cradled blade shaver is guided downwards, thereby effectively removing the moisture on the blade shaver. Corrosion of the blade part is thus prevented, thereby maintaining the cutting performance and durability for an extended period of time.

The effect of the present disclosure is not limited thereto, and other effects not mentioned will be clearly understood by those of ordinary skill in the art to which the present disclosure belongs from the following description.

### BRIEF DESCRIPTION OF THE DRAWINGS

FIG. 1 is a perspective view of a blade shaver cradle according to an embodiment of the present disclosure.

FIG. 2 is an exploded perspective view of a blade shaver cradle according to an embodiment of the present disclosure.

FIG. 3 is an operation state view of a blade shaver cradle according to an embodiment of the present disclosure.

FIG. 4 is a perspective view of a front part of a blade shaver cradle according to an embodiment of the present disclosure.

FIG. 5 is a perspective view of a rear part of a blade shaver cradle according to an embodiment of the present disclosure.

FIG. 6 is a cross-sectional view taken along line A-A of FIG. 1 when a shaver is cradled.

FIG. 7 is a cross-sectional view taken along line B-B of FIG. 1 when a shaver is cradled.

FIG. 8 is a state view in which a blade shaver is cradled in a blade shaver cradle according to an embodiment of the present disclosure.

### MODE FOR CARRYING OUT THE INVENTION

Hereinafter, embodiments of the present disclosure will be described in detail with reference to the accompanying drawings. In this case, it should be noted that in the accompanying drawings, the same components are denoted by the same reference numerals as much as possible. In addition, detailed descriptions of well-known functions and configurations that may obscure the gist of the present disclosure will be omitted. For the same reason, some components are exaggerated, omitted, or schematically illustrated in the accompanying drawings.

In addition, throughout the specification, when a certain part “includes” a certain component, the part does not exclude another component but may further include another component, unless the context clearly dictates otherwise. In addition, throughout the specification, “on” refers to a top or bottom of a target, and does not necessarily mean the top of the target based on a direction of gravity.

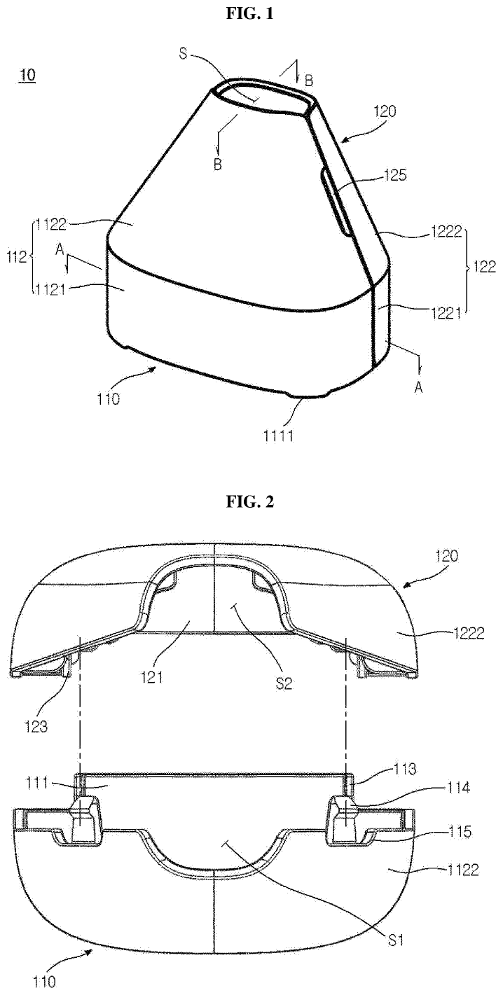

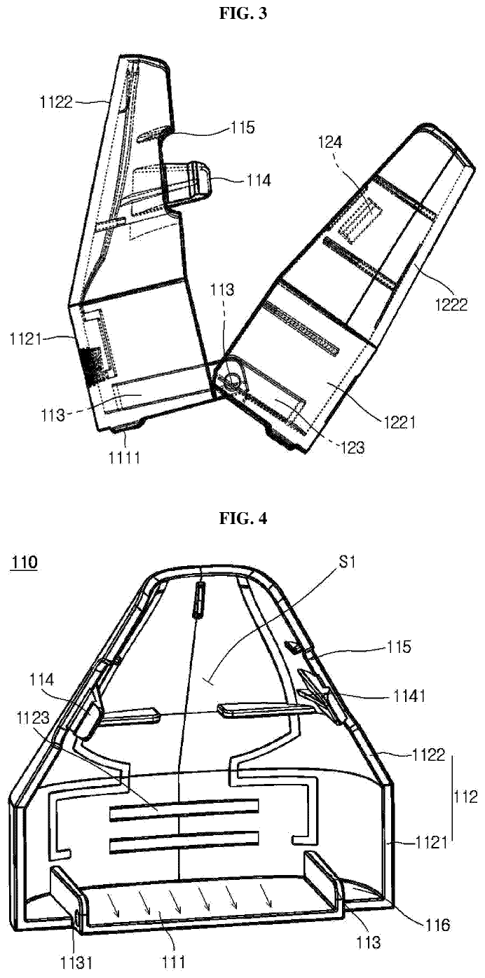

Referring to FIGS. 1 to 3, a blade shaver cradle 10 according to an embodiment of the present disclosure is for receiving a predetermined area of a blade shaver including a blade part and a handle such that the blade shaver is cradled therein, and includes a front part 110 and a rear part 120.

The front part 110 includes a first bottom plate 111 and a front plate 112, the front plate 112 extending upwards in an area other than a rear surface of the first bottom plate 111 to form a first receiving space S1 that is open.

The rear part 120 includes a second bottom plate 121 and a rear plate 122, the rear plate 122 extending upwards in an area other than a front surface of the second bottom plate 121 to form a second receiving space S2 that is open.

The rear surface of the first bottom plate 111 and the front surface of the second bottom plate 121 are pivotably coupled to each other, and an open rear surface of the front plate 112 and an open front surface of the rear plate 122 are coupled to each other to form a receiving space S for receiving the blade part and an area of the handle, and thus the blade shaver may be stably cradled and moisture may be effectively removed from the blade shaver. Also, upper end portions of the front plate 112 and the rear plate 122 are closely coupled to the handle of the blade shaver to prevent water from flowing into an upper portion of the cradle. Water droplets splashing and falling from the bathroom or toilet in which a blade shaver is mainly used may be prevented from entering the upper portion.

Hereinafter, each component will be described in more detail.

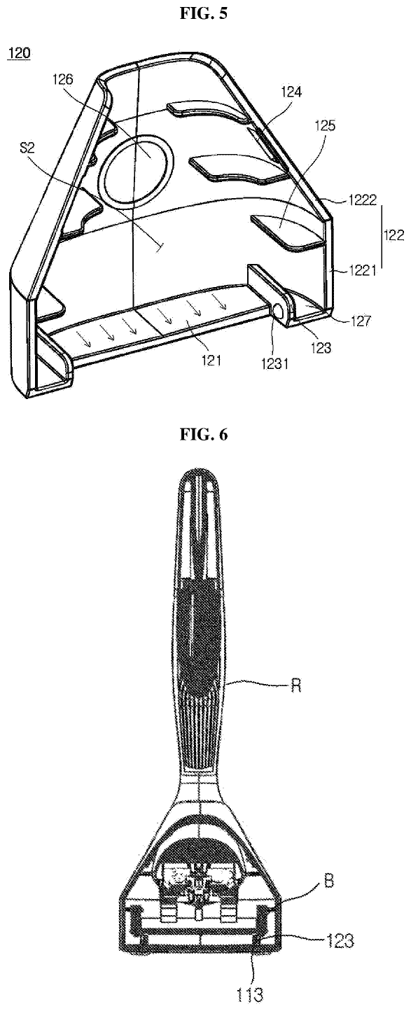

Referring to FIGS. 4 to 8, the front part 110 and the rear part 120 of the blade shaver cradle 10 will be described in more detail. The front part 110 and the rear part 120 are differentiated for convenience of description in the present disclosure, and the effect and performance do not change according to the arrangement of the front and rear surfaces in the present disclosure.

The front part 110 is coupled to the rear part 120 to form a front surface area of the blade shaver cradle 10, and includes the first bottom plate 111, the front plate 112, a first support portion 113, an insertion portion 114, a slit hole 115, and a weight 116.

The first bottom plate 111 may be formed in a substantially plate-shaped rectangle. The first bottom plate 111 decreases relatively in thickness toward the open rear surface, and thus a gradient is formed along the rear surface. Accordingly, when falling to the first bottom plate 111, moisture is guided along the gradient, and thus water may not be accumulated inside and may be discharged to the outside. Therefore, by inducing the receiving space not to be humid, safe protection may be achieved in an environment in which corrosion of the blade part may occur.

In addition, a lower surface of the first bottom plate 111 may include at least one close contact prevention portion 1111 protruding and extending downward so as not be in close contact with and to be spaced apart from a bottom surface on which the cradle is placed. The close contact prevention portion 1111 separates the first bottom plate 111 upwards so that moisture discharged to the outside via the gradient of the first bottom plate 111 may be discharged more effectively.

The front plate 112 extends upwards in the area other than the rear surface of the first bottom plate 111. The front plate 112 has a substantially “⊏” cross-sectional shape on a planar basis to form the first receiving space 51 that is open, and includes a first front plate 1121 and a second front plate 1122. The first front plate 1121 extends vertically in a circumferential direction of the first bottom plate 111. Also, the second front plate 1122 is integrally formed with the first front plate 1121 by extending upwards from an upper end of the first front plate 1121 and gradually narrows toward an upper portion of the second front plate 1122. In this case, the second front plate 1122 is inclined toward the rear surface so that a receiving position of a blade shaver may be more easily recognized, and a blade part B and a handle of a blade shaver R may be more efficiently received. Also, in this case, at least one of the first front plate 1121 and the second front plate 1122 may include a plurality of holes 1123 communicating with the outside to increase ventilation.

First support portions 113 extend upwards from both sides of an area, which are spaced apart from each other in a direction perpendicular to the blade part B on an upper surface of the first bottom plate 111 so as not to be in contact with a blade of the blade part B. In this case, a concave groove 1131 is formed in each of both outer side surfaces of the first support portion 113, and arranged to have a short separation distance equal to a thickness of a second support portion 123. The first support portion 113 is not in contact with the shaver blade of the blade part B and supports both ends that fix and support the shaver blade, and thus moisture may be effectively removed from the shaver blade while the shaver blade may be protected. In this case, an upper end of the first support portion 113 may be coated with silicone so that the blade part may be in close contact therewith without shaking.

The insertion portion 114 has a coupling structure in which a step is formed by protruding forward so as to be inserted into an insertion groove 124. In this case, a reinforcement portion 1141 coupled by supporting the insertion portion 114 on an inner circumferential surface of the second front plate 1122 may be provided. The reinforcement portion 1141 may increase an elastic restoring force of the insertion portion 114 and allow the insertion portion 114 not to be separated from and to be firmly fixed to a second rear plate 1222. Therefore, when the insertion portion 114 is coupled to the insertion groove 124, the insertion portion 114 is not separated from the insertion groove 124 until a physical external force is applied, and thus a coupling state of the front part 110 and the rear part 120 may be maintained.

The slit hole 115 is formed to have a greater width than a width of the insertion portion 114 and communicate with the internal receiving space. In this case, because the insertion portion 114 protrudes forward from an inner side surface of the second front plate 1122, the entire length of the slit hole 115 is communicated with the internal receiving space . Therefore, when the insertion portion 114 and the insertion groove 124 coupled to each other are separated, a gap formed via the slit hole 115 may be used for the separation, and a passage through which internal moisture and the like may be discharged may be additionally included to maintain the receiving space not to be in a humid state.

The weight 116 is arranged on an upper side of the first bottom plate 111 between the first support portion 113 and an inner circumferential surface of the first front plate 1121. The weight 116 brings the center of gravity closer to the bottom surface so that the blade shaver cradle 10 may be stably placed without being overturned. Preferably, the weight 116 may be formed of a metal material of stainless steel or aluminum having excellent corrosion resistance.

The rear part 120 is coupled to the front part 110 to form a rear surface area of the blade shaver cradle 10, and includes the second bottom plate 121, the rear plate 122, the second support portion 123, the insertion groove 124, a shaver support portion 125, a fixing groove 126, and a weight 127.

The second bottom plate 121 may be formed in a substantially plate-shaped rectangle. The second bottom plate 121 decreases relatively in thickness toward the open front surface, and thus a gradient is formed along the front surface. Accordingly, when falling to the second bottom plate 121, moisture is guided along the gradient, and thus water may not be accumulated inside and may be discharged to the outside. Therefore, by inducing the receiving space not to be humid, safe protection may be achieved in an environment in which corrosion of the blade part may occur.

In this case, while the first bottom plate 111 and the second bottom plate 121 are coupled to each other, a predetermined gap G is formed between neighboring surfaces, and water may be discharged along the gap G. In addition, the second bottom plate 121 may include at least one close contact prevention portion 1111 that protrudes and extends downward on a bottom surface, like the first bottom plate 111.

The rear plate 122 extends upwards in the area other than the front surface of the second bottom plate 121 to form the second receiving space S2. In this case, the rear plate 122 has a substantially “⊏” cross-sectional shape on a planar basis to form the second receiving space S2 that is open, and includes a first rear plate 1221 and a second rear plate 1222. The first rear plate 1221 extends vertically in a circumferential direction of the second bottom plate 121. Also, the second rear plate 1222 is integrally formed with the first rear plate 1221 by extending from an upper end of the first rear plate 1221 and gradually narrows toward an upper portion of the second rear plate 1222. While upper portions of the first rear plate 1121 and the second front plate 1222 are coupled to a handle of a shaver, the handle of the shaver standing vertically may be guided to achieve a weight balance in an upright state. In embodiments of the present disclosure, the second rear plate 1222 is formed with relatively steeper inclination than the second front plate 1122 to achieve a weight balance and stand vertically.

Second support portions 123 extend upwards from both sides of an area, which are spaced apart from each other in a direction perpendicular to the blade part on an upper surface of the second bottom plate 121 so as not to be in contact with a blade of the blade part. In this case, the second support portion 123 includes a ball portion 1231 formed in an approximately hemispherical shape on each of both inner peripheral surfaces. Accordingly, the second support portion 123 may be coupled to the first support portion 113 to form a structure in which the concave groove 1131 and the ball portion 1231 are coupled to each other and pivots together. In this case, when the concave groove 1131 and the ball portion 1231 are coupled to each other, as predetermined areas of the second support portion 123 and the first support portion 113 overlap with each other, the blade part of the blade shaver may be further stably supported, and opening/closing of the front part 110 and the rear part 120 is facilitated such that the blade shaver may be taken out or received therein more conveniently. In the present disclosure, because the front part 110 and the rear part 120 are formed of a plastic material, the front part 110 and the rear part 120 may be separated from and combined to each other via an elastic restoring force. An upper end of the second support portion 123 may be coated with silicone so that the blade part may be in further close contact therewith.

The insertion groove 124 is formed symmetrically in both sides of the second rear plate 1222 and is coupled to the insertion portion114 to maintain the front part 110 and the rear part 120 in a fixed state. In the present disclosure, as an example, the insertion groove 124 is formed in the second rear plate 1222, but may also be formed in the second front plate 1122, and a formation position of the insertion groove 124 is not limited thereto.

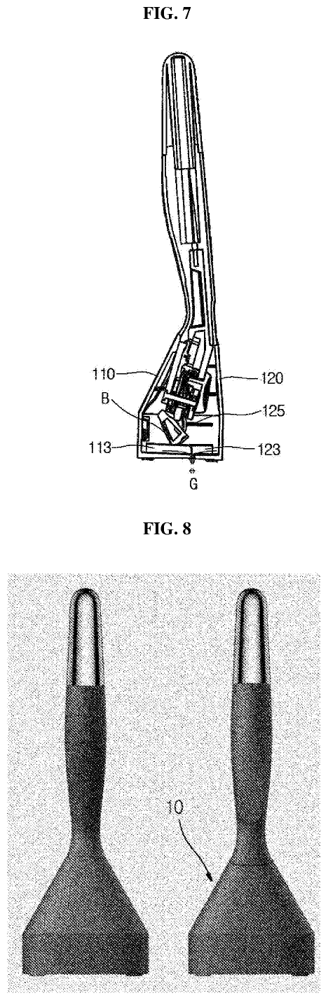

The shaver support portion 125 may be spaced apart from an upper end of the second support portion 123 by a predetermined distance, and a plurality of shaver support portions 125 may be arranged upwards. When the blade part B is arranged in the receiving space S, the shaver support portion 125 may allow the blade part B to be arranged and tilted between the shaver support portion 125 and the second support portion 123 in a pivoted state at a predetermined angle as shown in FIG. 7, thereby further effectively guiding moisture on the blade part B downward. In this case, the shaver support portion 125 may be formed in three steps to support a shaver R, thereby further stably supporting the shaver R.

The fixing groove 126 is formed in an intermediate area of the second rear plate 1222. A shape of the fixing groove 126 may be formed in a shape corresponding to a blade replacement button of the blade part of the blade shaver. Accordingly, the blade shaver replacement button has a protruding structure, the fixing groove 126 is formed as a groove having a shape corresponding thereto, and thus the blade shaver replacement button is arranged in the groove. Therefore, when the blade shaver is arranged in the receiving space S, the blade shaver replacement button may prevent the blade part from being separated from the second rear plate 1222 to maintain the blade shaver in a coupled state as it is.

Because the weight 127 has substantially the same configuration as that included in the front part 110, detailed description will be omitted hereinafter.

Meanwhile, embodiments of the present disclosure disclosed in the present specification and drawings are merely presented as specific examples to easily explain the technical contents of the present disclosure and help the understanding of the present disclosure, and are not intended to limit the scope of the present disclosure. It will be apparent to those of ordinary skill in the art to which the present disclosure pertains that other modifications based on the technical idea of the present disclosure may be implemented in addition to the embodiments disclosed herein.

1. A blade shaver cradle capable of cradling a blade shaver by receiving a predetermined area of the blade shaver, the blade shaver including a blade part and a handle, the blade shaver cradle comprising:
a front part comprising a first bottom plate and a front plate, the front plate extending upwards in an area other than a rear surface of the first bottom plate to form a first receiving space that is open; and
a rear part comprising a second bottom plate and a rear plate, the rear plate extending upwards in an area other than a front surface of the second bottom plate to form a second receiving space that is open,
wherein the front part and the rear part are coupled such that the rear surface of the first bottom plate and the front surface of the second bottom plate are pivotable, and an open rear surface of the front plate and an open front surface of the rear plate are coupled to each other to form a receiving space in which the blade part and an area of the handle are received,
wherein the first bottom plate and the second bottom plate respectively comprise first support portions and second support portions, each of the first support portions and the second support portions being spaced apart from each other in a direction perpendicular to the blade part and extending upwards from both sides of an area not being in contact with a blade of the blade part, a predetermined gap is formed between neighboring surfaces, and a gradient is formed toward the gap to guide water to be discharged,
wherein inner circumferential surfaces of upper ends of the front plate and the rear plate in a coupled state are in close contact with the blade shaver to prevent water from flowing into inside,
wherein a second rear plate of the rear plate is formed at a relatively steeper inclination than a second front plate of the front plate to achieve a weight balance and stand vertically.

2. The blade shaver cradle of claim 1, wherein the first bottom plate and the second bottom plate comprise at least one close contact prevention portion protruding and extending downward from bottom surfaces of the first bottom plate and the second bottom plate so that the first bottom plate and the second bottom plate are not in close contact with and spaced apart from a bottom surface.

3. The blade shaver cradle of claim 1, wherein the front plate includes a first front plate vertically extending in a circumferential direction of the first bottom plate, and the first front plate includes a hole communicating with outside.
